(19) United States
(12) Patent Application Publication
(10) Pub. No.: US 2026/0195878 A1
(43) Pub. Date: Jul. 9, 2026

(54) EFFICIENT MANIPULATION OF VIDEO IN VIDEO CONFERENCING

(71) Applicant: Intel Corporation, Santa Clara, CA (US)

(72) Inventors: Hava Matichin, Petah Tikva (IL); Dor Barber, Herzliya (IL); Shlomo Bugdary, Rishon LeZion (IL); Moran Klein, Ra’anana (IL); Rony Zatzarinni, Tel Aviv (IL)

(73) Assignee: Intel Corporation, Santa Clara, CA (US)

(21) Appl. No.: 19/551,262

(22) Filed: Feb. 26, 2026

(51) Int. Cl. G06T 5/92; G06T 3/40; G06T 7/10; G06V 10/82; G06V 20/40

(52) U.S. Cl. CPC G06T 5/92; G06T 3/40; G06T 7/10; G06V 10/82; G06V 20/44

(57) ABSTRACT

Implementing video manipulation that can deliver professional-quality results while maintaining real-time performance is not trivial. To address this technical challenge, a dual parallel path processing system can be implemented. In a pipeline parallel to a main image processing pipeline, low-resolution images of a video can be processed, such as by a neural network, to generate gain maps that specify spatially-varying corrections for a variety of applications such as face relighting, content emphasis/de-emphasis, graphics overlay effects, and scene tone-mapping. These gain maps are upscaled through existing image processing unit hardware, and applied on or to the full-resolution, high bit-depth images. This approach achieves superior image quality with minimal computational overhead, little to no degradation to processing latency, and minimal additional power consumption.

### BACKGROUND

Cameras are optical systems that capture and record light to create images. A camera can include components such as lenses, sensors, and processing units that process the signals captured by the sensors. Cameras often face image quality issues or artifacts that impact user experience and product value.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an imaging system, according to some embodiments of the disclosure.

FIG. 2 illustrates a video processing system involving an image processing unit, according to some embodiments of the disclosure.

FIG. 3 illustrates a video processing system involving an image processing unit, according to some embodiments of the disclosure.

FIG. 4 illustrates gain map generation, according to some embodiments of the disclosure.

FIG. 5 illustrates a neural network for generating a gain map, according to some embodiments of the disclosure.

FIG. 6 is a flowchart illustrating a method for training a neural network to generate a gain map, according to some embodiments of the disclosure.

FIG. 7 is a flowchart illustrating a method for efficient manipulation of video, according to some embodiments of the disclosure.

FIG. 8 is a block diagram of an example computing device, according to some embodiments of the disclosure.

### DETAILED DESCRIPTION

### Overview

An imaging system can include a sensor and an image processing unit that processes the signals captured by the sensor. The sensor may capture raw images of a video, and the image processing unit may receive the raw images and produce processed images of a processed video. The image processing unit can be referred to as an image signal processor in some contexts. The processed video may be used by a downstream user application, such as a video conferencing application, and the processed video may be rendered for display. The processed video may be encoded for transmission. In some cases, the processed video may be recorded onto media and stored for later consumption.

The image processing unit can include dedicated hardware acceleration logic or circuits that can manipulate the raw images of the video. One example of video manipulation that can be performed by the image processing unit is tone-mapping manipulation of images. Applications that rely on tone-mapping manipulation, which can selectively adjust brightness and contrast properties across different image regions, are becoming increasingly important for high-quality video conferencing. Tone-mapping manipulation can transform an image by applying a spatially and intensity-dependent gain function that compresses dynamic range while preserving perceptual contrast. Rather than replacing pixel values, tone-mapping may scale high-bit-depth image signals using a luminance-dependent gain to reduce highlight saturation and lift shadow detail. These applications encompass a wide range of techniques and use cases, from user experience-focused applications such as face relighting or content highlighting, to image quality applications such as backlight correction.

One example of a tone-mapping-based application is relighting. Scene or object relighting, e.g., face relighting, can improve appearance under various lighting conditions by adjusting brightness and contrast in the affected regions. This application addresses common video conferencing scenarios where users appear too dark due to backlighting or have harsh shadows/uneven face illumination from directional lighting sources. In an unprocessed image, a user's face may appear underexposed and unevenly illuminated. In a processed image where a gain map is applied to address lighting in the face region, the result is an appearance that would be achieved using a right light setup.

Another example of a tone-mapping-based application is content emphasis and/or de-emphasis, which involves highlighting and/or de-emphasizing specific objects or regions in the scene. For example, when a user points to text or an object, content emphasis can brighten that area while darkening the background to draw attention to the relevant content. In another example, content de-emphasis can darken or dim the background to draw attention to the foreground person.

Another example of a tone-mapping based application is graphics overlay and video effects, which can add text and/or drawings overlay, video effects (e.g., add bubbles/fireworks or other moving visual effects), translucent visual effects, or watermarks. In some applications, the overlay and effects can be added in a selected region of the image (e.g., in a region that is not a user's face or body, or only on a specific part of the user's body).

Another example of a tone-mapping based application is scene tone-mapping, which provides overall image quality improvement through intelligent dynamic range compression and local enhancements. For example, scene tone-mapping can manipulate images captured in high-contrast scene scenarios (where the background is bright, such as a window) and implement backlight correction to maintain proper brightness for the foreground subject. Scene tone-mapping can provide high dynamic range compression with minimal loss of details. Video captured in automotive settings can often be captured in high-contrast scene scenarios.

The growing adoption of video conferencing and ubiquitous video capturing applications has created a demand for high-quality, low-cost solutions that current solutions, which rely on post-processing solutions or traditional image processing unit methods, struggle to meet. For example, in real-time video conferencing, the demands include 30+ frames per second (FPS) processing with zero-to-low latency, low power consumption for battery-powered devices, low computational complexity for resource-constrained edge devices, and minimal memory bandwidth usage. In addition, tone-mapping manipulation solutions should achieve high-quality videos, which necessitates having semantic knowledge for intelligent decision-making and high bit-depth processing for superior image quality. These requirements create significant challenges for implementing tone-mapping manipulation applications that can deliver professional-quality results while maintaining real-time performance.

Implementing video manipulation that can deliver professional-quality results while maintaining real-time performance is not trivial. To address this technical challenge, a dual parallel path processing system can be implemented. By expressing the tone-mapping operation in the main image processing pipeline as a multiplicative gain operation, additional spatially-varying gains or gain maps, such as those derived from semantic analysis or retrieved from a source of gain maps, can be composed with the tone-mapping gain function to enable selective enhancement or suppression of image regions prior to bit-depth reduction. In a pipeline parallel to the main image processing pipeline, low-resolution images of a video can be processed, such as by a neural network, to generate gain maps that specify spatially-varying corrections for a variety of applications such as face relighting, content emphasis/de-emphasis, graphics overlay effects, and scene tone-mapping. These gain maps are upscaled through hardware logic or circuits in the image processing unit, and applied on or to the full-resolution, high bit-depth images. This dual parallel path processing approach achieves superior image quality with minimal computational overhead, little to no degradation to processing latency, and minimal additional power consumption.

In some embodiments, neural network-guided tone-mapping can be integrated directly with the main image processing pipeline. Specifically, a lightweight neural network model that processes a low-resolution version of the input image (e.g., downscaled by 4× to 8× or more) and/or other signals in the video can extract meaningful information from the video, such as semantic understanding, scene lighting source analysis, tone-mapping histogram-based information, and content-of-interest detection. This neural network model can be used to produce a gain map that specifies spatially-varying corrections for different image regions. The gain map is then upscaled using hardware logic or circuits of the image processing unit and applied to the image by leveraging a tone-mapping part already provided in the image processing unit while the image data still maintains its full bit-depth (e.g., having a bit-depth of 10-20+ bits). The gain map is computed in parallel with the main image processing pipeline, utilizing a coarse-resolution stream.

Video manipulation can be achieved in an efficient manner through intelligent adjustment of brightness and contrast in video images by combining a tone-mapping function with a spatially-varying gain map that controls how different regions of an image are enhanced or suppressed. The video manipulation system can include a gain map generation pipeline that produces a gain map and an image processing pipeline that applies that gain map to an image while the image is still represented at high precision. By separating how the gain map is generated from how it is applied, the approach supports flexible, content-aware image manipulation without replacing the underlying image processing pipeline.

During processing, the image processing pipeline first upsamples the gain map so that the gain map resolution matches the resolution of the image. A composite gain function is then applied to the image to generate a processed image. This composite gain function combines a gain function, such as one derived from a tone-mapping curve, with the spatially-varying gain values from the upscaled gain map. In some implementations, the composite gain function also incorporates a details map that selectively boosts fine image details, helping preserve texture and structure while the dynamic range is compressed. After these gain operations are applied, the bit-depth of the processed image is reduced, which helps avoid quantization artifacts and loss of detail.

The image processing pipeline may be implemented directly in image-processing hardware, such as an image signal processor or image processing unit, enabling real-time operation as part of a normal video manipulation or processing pipeline. The gain map can be generated efficiently using a downscaled version of the image, for example at a resolution reduced by a factor of four or more, which significantly lowers computational cost while retaining sufficient information to guide local brightness and contrast adjustments.

The gain map generation pipeline supports multiple sources and generation methods. In some cases, the gain map may be retrieved from storage, such as when applying a fixed overlay or predefined visual effect. In other cases, the gain map may be constructed from a description of a graphic or visual effect, allowing translucent overlays or effects to be applied by modulating brightness rather than overwriting pixel values. The gain map may also be generated based on image segmentation, where different regions of the image are classified into segmentation classes and assigned different gain values accordingly. In some cases, the gain map may be constructed from a combination of sources or types of information about the video. In some implementations, the gain map can be generated using a neural network that operates on a downscaled version of the image or related derived data, enabling content-aware adjustments such as face relighting or backlight correction. The gain map generation pipeline may also include an event detector that analyzes image content, audio from the video, or both, and generates or modifies the gain map in response to detected events. Together, these features enable flexible, high-quality tone-mapping manipulation that adapts to scene content while preserving image fidelity.

The dual parallel path processing approach leverages high bit-depth processing. Unlike post-processing solutions that operate on low bit-depth data (e.g., 8-bit image data), the approach processes images within the main image processing pipeline before bit-depth reduction, maintaining the full sensor dynamic range (e.g., 10-12 bits in a regular sensor, 12-16 bits in high dynamic range (HDR) sensors, and can reach up to 20-24 bits). High bit-depth processing benefits all application areas, such as relighting, content emphasis/de-emphasis, and scene tone-mapping, by preserving subtle details and enabling higher-quality corrections.

The dual parallel path processing approach can achieve hardware acceleration by leveraging tone-mapping blocks provided in the image processing unit for efficient processing, consuming much less power than software alternatives.

The dual parallel path processing approach can achieve computational efficiency through low-resolution processing. The gain map generation pipeline can exploit the scaling and image signal processing hardware provided in the image processing unit to process downscaled images (e.g., images downscaled with an 8× reduction) and generate low-resolution gain maps. The upscaling hardware provided in the image processing unit can be reused to obtain the upscaled gain map. Leveraging the hardware already on the image processing unit reduces computational cost (e.g., by 64× for 8× scale reduction) while maintaining sufficient spatial resolution for accurate enhancement decisions.

The dual parallel path processing approach can achieve semantic and context awareness and provide intelligent understanding of image content to emphasize (or de-emphasize) elements of interest and apply targeted corrections. The ability to understand the context/semantics of the scene and identify important or salient objects represents a significant advantage over other implementations that rely only on basic face crop region information as semantic data, enabling sophisticated applications like content emphasis/de-emphasis and intelligent tone-mapping decisions.

The dual parallel path processing approach enables integrated image processing unit control and coordinated operation between the neural network-generated gain map and the processing blocks in the main image processing pipeline. For example, during face relighting operations, the global tone-mapping operation can consider the brightening applied to face regions and prevent oversaturation, ensuring natural-looking results that traditional post-processing cannot achieve.

The dual parallel path processing approach can achieve flexible gain map operations. For scene tone-mapping within the image processing unit, the gain map approach provides more flexibility and significantly lower computational cost compared to other complex operations, while maintaining high-quality results.

### Example Imaging System Having a Main Image Processing Pipeline

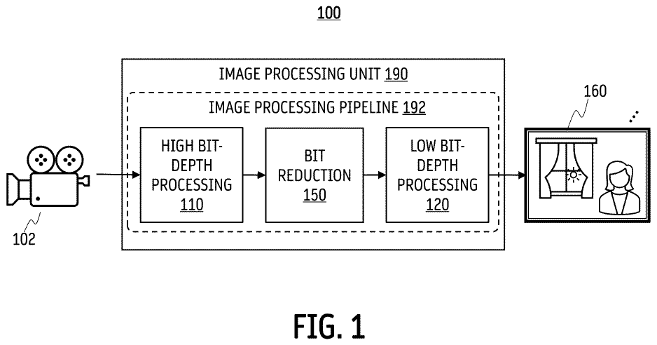

FIG. 1 illustrates imaging system 100, according to some embodiments of the disclosure. Imaging system 100 includes image sensor 102 and image processing unit 190. Image sensor 102 can output one or more raw images of a video. Image processing unit 190 can generate one or more processed images 160 of the video. Image processing unit 190 can implement or execute image processing pipeline 192.

Image sensor 102 converts light from a scene into pixel signals. Image sensor 102 can include a two-dimensional array of light-sensitive pixels (e.g., photodiodes) that integrate incoming photons over an exposure interval to accumulate charge, and readout circuitry that converts accumulated charge into pixel values of a raw image delivered to image processing unit 190. Image sensor 102 can be implemented using different sensor technologies and shutter modes. Image sensor 102 can be a complementary metal-oxide-semiconductor (CMOS) image sensor, which supports fast readout and flexible control, or a charge-coupled device (CCD) image sensor, which transfers charge for readout using different internal mechanisms. One or more processed images 160 comprise processed image data generated by image processing unit 190 after application of image processing pipeline 192. One or more processed images 160 can represent a final output video to be stored in memory, transmitted to another processing stage, rendered for display to a user, or provided to a downstream application.

Image processing pipeline 192 may include one or more stages, parts, or blocks, such as one or more of: high bit-depth processing 110, bit reduction part 150, and low bit-depth processing 120. High bit-depth processing 110 can include operations that consume high-precision sensor data to perform early-stage image conditioning, such as tone-mapping or gain-based manipulation. High bit-depth processing 110 can preserve dynamic range and fine gradients so that later manipulations to the image data do not introduce banding or visible artifacts.

Bit reduction part 150 comprises logic to transform high-bit-depth pixel data into a lower-bit-depth representation appropriate for downstream processing or encoding. Bit reduction part 150 can include quantization, companding, or hardware-based truncation. Bit reduction part 150 can be positioned after high bit-depth processing 110, so that important details are preserved before precision is reduced.

Low bit-depth processing 120 comprises one or more post-tone-mapping image enhancement functions that operate on reduced-precision data. Low bit-depth processing 120 can include sharpening, denoising, or color adjustments appropriate for display-ready video. Low bit-depth processing 120 can use the output of bit reduction part 150 to perform lightweight refinements without reintroducing artifacts that would otherwise arise if gain modulation occurred after bit-depth truncation. In some examples, low bit-depth processing 120 may incorporate temporal smoothing for video.

In some embodiments, image processing pipeline 192 comprises high bit-depth processing 110, bit reduction part 150, and low bit-depth processing 120, arranged sequentially to transform raw or semi-processed image data from image sensor 102 into a display-ready frame, e.g., as part of one or more processed images 160.

Image processing unit 190 can include hardware logic dedicated to high-performance, low-latency video operations. Image processing unit 190 can implement fixed-function accelerators, programmable blocks, or a combination thereof to ensure real-time throughput. In some examples, image processing unit 190 may house one or more of hardware scalers, tone-mapping engines, image signal processing circuits, digital signal processors, filtering hardware, and neural network accelerators used to process image data.

### Examples of Efficient Video Manipulation Leveraging an Image Processing Unit

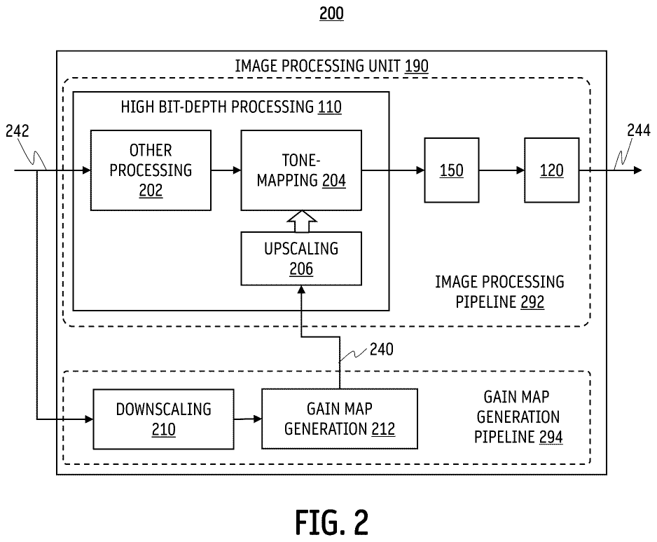

FIG. 2 illustrates video processing system 200 involving image processing unit 190, according to some embodiments of the disclosure. Video processing system 200 can include image processing pipeline 292 and gain map generation pipeline 294. Gain map generation pipeline 294 can output gain map 240. Image processing pipeline 292 can be implemented similarly to image processing pipeline 192 of FIG. 1, with one or more modifications to integrate video manipulation using gain map 240. One or more components or logic of image processing pipeline 292 and optionally one or more components of gain map generation pipeline 294 can be implemented using hardware in image processing unit 190.

Effectively, high-quality, cost-effective video manipulations are integrated into image processing pipeline 292 or other pipelines in image processing unit 190. Gain map generation pipeline 294 can process low-resolution images to generate semantic-aware gain maps that specify spatially-varying corrections for applications such as face relighting, content emphasis/de-emphasis, and scene tone-mapping. These gain maps are upscaled in image processing pipeline 292 and applied alongside tone-mapping through dedicated hardware that increases reuse of existing components in image processing unit 190, thereby reducing hardware area and power consumption.

Image processing pipeline 292 can process an image of video 242 and generate a processed image of processed video 244. Image processing pipeline 292 can include upscaling part 206 to generate an upscaled gain map based on gain map 240 from the gain map generation pipeline 294. Upscaling part 206 may be referred to as an upscaler. Image processing pipeline 292 can include a gain function application part, e.g., tone-mapping 204, to apply a composite gain function to the image to generate a processed image. The composite gain function being applied can be based on a gain function and the upscaled gain map. Image processing pipeline 292 can include bit reduction part 150 to reduce a bit-depth of the processed image.

Herein, a gain function application part manipulates an image by applying one or more gain functions that scale pixel values to adjust brightness, contrast, or dynamic range while preserving underlying image structure. Rather than replacing pixel values, the gain function application part modifies the image through multiplicative scaling, which allows global adjustments and spatially-varying adjustments to be composed in a controlled manner. One example of such manipulation is tone-mapping, in which a gain function derived from a tone-mapping curve compresses dynamic range by reducing highlight intensity and lifting shadow regions, and this tone-mapping gain can be further combined with additional gain components, such as detail-preservation gains or spatial gain maps, to achieve content-aware enhancement before bit-depth reduction.

Herein, applying a composite gain function encompasses both forming a single combined gain function and applying multiple gain functions in sequence, because the individual gain contributions can be composed multiplicatively to produce an equivalent overall scaling of pixel values. In one implementation, multiple gain functions, such as a tone-mapping gain function, a spatially-varying gain derived from an upscaled gain map, and optionally a detail-preservation gain, are mathematically combined into a single composite or combined gain function that is applied in one operation, for example as a per-pixel multiplication. In other implementations, those same gain functions are applied serially in successive stages of an image processing pipeline, where each stage scales the image by an additional gain, resulting in an overall effect that is functionally equivalent to applying the combined gain function while preserving flexibility in where and how each gain is introduced.

High bit-depth processing 110 can include operations that preserve high-precision pixel information so that subsequent gain adjustments and tone-mapping functions maintain image detail. In some examples, image processing unit 190 may execute these operations using fixed-function hardware for real-time operation. In the example illustrated in FIG. 2, high bit-depth processing 110 comprises one or more of: other processing 202, tone-mapping 204, and upscaling part 206. Other processing 202 can include linear-domain corrections, black level correction, white balance adjustment, lens shading correction, defective pixel correction, green disparity correction, demosaicing, noise conditioning, noise reduction, or color adjustments that benefit from high-precision input values. Other processing 202 can act as a precursor stage to tone-mapping 204, enabling smoother tone-mapping transitions across varying lighting conditions. In some examples, other processing 202 may accept sensor metadata to refine or tune processing decisions. Operations in high bit-depth processing 110 can process signals at high bit-depth (e.g., 16-bit native support with optional compression up to 24-bit packed into a 16-bit format). For blocks performing linear domain processing, decompression can occur at the block's input stage. Tone-mapping 204 (global and local) in high bit-depth processing 110 may be followed by bit reduction part 150 and subsequent low bit-depth processing 120.

Tone-mapping 204 comprises logic to apply a gain function, which may be based on a tone-mapping function or a tone-mapping curve. Absent an upscaled gain map from upscaling part 206, the operation of tone-mapping 204 to apply a gain function to a full-resolution red-green-blue (RGB) image, RGB_output(x,y), can be represented as follows:

$$RGB\_output ( x , y ) = RGB\_linear ( x , y ) * GTM\_gain ( x , y )$$

RGB_linear(x,y) is a 24-bit linear domain input (e.g., if using lower bit-depths, the data can be stored in the most significant bits (MSBs)). GTM_gain(x,y) is a global tone-mapping gain function (e.g., luminance-dependent, or max (R,G,B) dependent). (x,y) refer to pixel coordinates of the image. RGB_output(x,y) is the processed output image.

Gain map generation pipeline 294 comprises one or more of: downscaling 210 and gain map generation 212.

Downscaling 210 can reduce the resolution of the input image, for example by a factor of four, eight, or more. One or more operations in gain map generation 212 can be performed based on a downscaled version of the image in video 242. Downscaling 210 can supply a compact representation suitable for low-power, low-complexity semantic analysis, neural-network inference, segmentation, or event detection. In some examples, downscaling 210 may use hardware binning paths, downsampling logic, or subsampling circuits already present in image processing unit 190.

Gain map generation 212 comprises logic to generate a gain map, e.g., GM_lowres(x,y), that can influence tone-mapping 204. Gain map generation 212 can include one or more of retrieval of gain maps, segmentation-based gain map generation, neural-network-based gain map generation, graphic-based gain-map construction, and event-triggered gain-map selection or construction. Gain map generation 212 can output a spatially-varying gain map, at a low-resolution, which can be upscaled via upscaling part 206.

Upscaling part 206 comprises one or more hardware or firmware-implemented scaler or resampling blocks configured to upscale a gain map, e.g., GM_lowres(x,y) from a lower resolution to a full-resolution map, e.g., GM_upscaled(x,y), suitable for use in high bit-depth processing 110. Upscaling part 206 can include interpolation, filtering, or edge-aware resampling strategies that allow spatially-varying gain values to align precisely with high-precision image pixels. Upscaling part 206 can be performed using hardware or logic in image processing unit 190, such as hardware or logic resources from a low-contrast details extraction component of image processing unit 190. In some examples, upscaling part 206 may be optimized for power-efficient operation within image processing unit 190.

The upscaled gain map, e.g., GM_upscaled(x,y), from upscaling part 206 can be used as part of a composite gain function, e.g., combined_gain(x,y), that can be applied using logic or circuits in tone-mapping 204 to apply targeted brightness adjustments in high bit-depth processing 110. Tone-mapping 204 can combine a global luminance-dependent function, e.g., GTM_gain(x,y) with spatial gain contributions supplied from upscaling part 206, e.g., GM_upscaled(x,y). For example, combined_gain(x,y) can be calculated as follows:

$$combined\_gain ( x , y ) = GTM\_gain ( x , y ) * GM\_upscaled ( x , y )$$

Tone-mapping 204 can therefore apply a composite gain function, e.g., combined_gain(x,y), that merges tone-mapping operations with spatially-varying gain map values, enabling content-aware modulation before precision is reduced by bit reduction part 150. The upscaled gain map can modulate the tone-mapping function. The ordering of applying the upscaled gain map and applying the tone-mapping function is flexible, since the application of gain is multiplicative, as long as sufficient precision is preserved. The operation of tone-mapping 204 to apply a composite gain function, combined_gain(x,y) to a full-resolution RGB image, RGB_output(x,y), can be represented as follows:

$$RGB\_output ( x , y ) = RGB\_linear ( x , y ) * combined\_gain ( x , y )$$

RGB_linear(x,y) is a 24-bit linear domain input (e.g., if using lower bit-depths, the data can be stored in the most significant bits (MSBs)). combined_gain(x,y) is the composite gain function being applied in tone-mapping 204. RGB_output(x,y) is the processed output image.

Image processing pipeline 292 can apply the composite gain function, e.g., combined_gain(x,y) to the image before bit reduction part 150, aligning with the advantage of preserving dynamic range when applying spatially-varying enhancements. Image processing pipeline 292 can coordinate with gain map generation pipeline 294 to integrate upscaled gain maps into tone-mapping 204 in real-time. The gain map produced by gain map generation pipeline 294 can therefore drive the modulation applied by tone-mapping 204, ensuring that composite gain application occurs while the image still uses high-precision pixel values. Applying the composite gain function in high bit-depth processing 110 can preserve fine detail, reduce halo artifacts, and enable content-adaptive tone-mapping manipulation, providing a significant advantage over post-processing approaches that operate only on low-bit-depth data.

Bit reduction part 150 comprises logic to reduce the bit-depth of the processed image from tone-mapping 204. Bit reduction part 150 can quantize the high-precision result produced after tone-mapping 204 so that the output conforms to display, encoding, or pipeline constraints. In some examples, bit reduction part 150 may incorporate dithering or perceptual weighting.

Low bit-depth processing 120 comprises one or more additional operations that act upon the bit-reduced image. Low bit-depth processing 120 can include gamma correction, temporal denoise, sharpening, temporal smoothing, denoising, or color grading suited to video-ready output. Low bit-depth processing 120 can function as a stage that finalizes the processed image without reintroducing artifacts corrected during high bit-depth processing 110.

In some examples, gain map generation pipeline 294 may operate continuously, concurrently, or in parallel with image processing pipeline 292 to support dynamic effects such as backlight correction or face relighting.

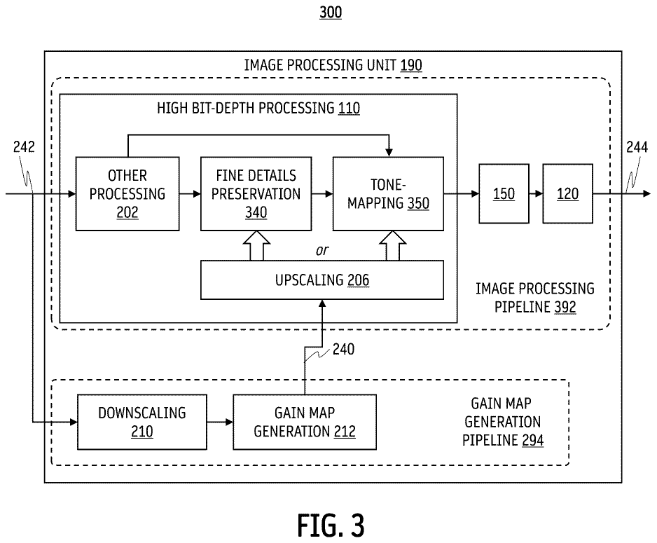

FIG. 3 illustrates video processing system 300 involving image processing unit 190, according to some embodiments of the disclosure. Video processing system 300 can include image processing pipeline 392 and gain map generation pipeline 294. Gain map generation pipeline 294 can output gain map 240. Image processing pipeline 392 can be implemented similarly to image processing pipeline 192 of FIG. 1 and image processing pipeline 292 of FIG. 2, with one or more modifications to integrate video manipulation using gain map 240. One or more components or logic of image processing pipeline 392 and optionally one or more components of gain map generation pipeline 294 can be implemented using hardware in image processing unit 190.

Effectively, high-quality, cost-effective video manipulations are integrated into image processing pipeline 392 or other pipelines in image processing unit 190. Gain map generation pipeline 294 can process low-resolution images to generate semantic-aware gain maps that specify spatially-varying corrections for applications such as face relighting, content emphasis/de-emphasis, and scene tone-mapping. These gain maps are upscaled in image processing pipeline 392 and applied alongside fine image details preservation and tone-mapping through dedicated hardware that increases reuse of existing components in image processing unit 190, thereby minimizing hardware area and power consumption.

Image processing pipeline 392 can process an image of video 242 and generate a processed image of processed video 244. Image processing pipeline 392 can include upscaling part 206 to generate an upscaled gain map based on gain map 240 from the gain map generation pipeline 294. Image processing pipeline 392 can include a gain function application part, e.g., tone-mapping 350, to apply a composite gain function to the image to generate a processed image. The composite gain function being applied can be based on a gain function, the upscaled gain map, and a details map. Image processing pipeline 392 can include bit reduction part 150 to reduce a bit-depth of the processed image.

In the example illustrated in FIG. 3, high bit-depth processing 110 comprises one or more of: other processing 202, fine details preservation 340, tone-mapping 350, and upscaling part 206. Fine details preservation 340 and tone-mapping 350 can be part of a gain manipulation part of image processing pipeline 392. Fine details preservation 340 operates at high bit-depth to preserve fine image details prior to tone-mapping 350 applying global/local tone-mapping. Fine details preservation can be beneficial to image quality because tone-mapping curves can compress signal ranges in some scenarios, potentially causing loss of low-contrast details. Tone-mapping 350 can apply the composite/combined gain function that incorporates the gain function (e.g., based on a tone-mapping curve), the upscaled gain map (e.g., from gain map generation pipeline 294), and a details map (e.g., generated by fine details preservation 340).

Absent an upscaled gain map from upscaling part 206, the operation of fine details preservation 340 derives a details map, e.g., details_factor(x,y). Fine details preservation 340 can compute per-pixel gains as follows:

$$details\_factor ( x , y ) = 1 + low\_contrast \_details ( x , y )$$

low_contrast_details(x,y) can be derived by applying a low-pass or multi-scale smoothing filter to an image to estimate a locally averaged signal and subtracting that estimate from the original image to isolate small-magnitude variations that are not strong edges. The resulting residual represents subtle texture and detail in regions of low-contrast, which can then be selectively amplified without significantly affecting high-contrast structures such as edges.

In some embodiments, the upscaled gain map, e.g., GM_upscaled(x,y), from upscaling part 206 can be combined with the details map. The upscaled gain map can be combined with the details map as follows:

$$details\_GM \_gain ( x , y ) = details\_factor ( x , y ) * ( 1 + GM\_factor * GM\_upscaled ( x , y ) )$$

GM_factor can be a parameter that is determined, configured, or calibrated by image processing unit 190. GM_factor can support positive or negative values for enhancement or suppression.

In some embodiments, details_GM_gain(x,y) can be combined with the gain function, such as the gain function derived from a tone-mapping curve, in tone-mapping 350 to derive a composite or combined gain function. Tone-mapping 350 can then apply the composite or combined gain function to apply targeted brightness adjustments in high bit-depth processing 110. Tone-mapping 350 can combine a global luminance-dependent function, e.g., GTM_gain(x,y) with details_GM_gain(x,y). For example, combined_gain(x,y) can be calculated as follows:

$$combined\_gain ( x , y ) = GTM\_gain ( x , y ) * details\_GM \_gain ( x , y )$$

Tone-mapping 350 can therefore apply a composite gain function, e.g., combined_gain(x,y) that merges tone-mapping operations with spatially-varying gain map values (e.g., combining or accounting for a details map and an upscaled gain map), enabling content-aware modulation before precision is reduced by bit reduction part 150. The upscaled gain map can modulate the tone-mapping function. The ordering of applying the upscaled gain map, applying the details map, and applying the tone-mapping function is flexible, since the application of gain is multiplicative, as long as sufficient precision is preserved. In some embodiments, the upscaled gain map from upscaling part 206 can be provided to fine details preservation 340. In some embodiments, the upscaled gain map from upscaling part 206 can be provided to tone-mapping 350 instead of fine details preservation 340. The operation of tone-mapping 350 to apply a composite gain function, combined_gain(x,y) to a full-resolution RGB image, RGB_output(x,y), can be represented as follows:

$$RGB\_output ( x , y ) = RGB\_linear ( x , y ) * combined\_gain ( x , y )$$

RGB_linear(x,y) is a 24-bit linear domain input (e.g., if using lower bit-depths, the data can be stored in the most significant bits (MSBs)). combined_gain(x,y) is the composite gain function being applied in tone-mapping 350. RGB_output(x,y) is the processed output image.

Image processing pipeline 392 can apply the composite gain function, e.g., combined_gain(x,y), to the image before bit reduction part 150, aligning with the advantage of preserving dynamic range when applying spatially-varying enhancements. Image processing pipeline 392 can coordinate with gain map generation pipeline 294 to integrate upscaled gain maps into tone-mapping 204 in real-time. The gain map produced by gain map generation pipeline 294 can therefore drive the modulation applied by tone-mapping 204, ensuring that composite gain application occurs while the image still uses high-precision pixel values. Applying the composite gain function in high bit-depth processing 110 can preserve fine detail, reduce halo artifacts, and enable content-adaptive tone-mapping manipulation, providing a significant advantage over post-processing approaches that operate only on low-bit-depth data.

In some examples, gain map generation pipeline 294 may operate continuously, concurrently, or in parallel with image processing pipeline 392 to support dynamic effects such as backlight correction or face relighting.

### Examples of Gain Map Generation

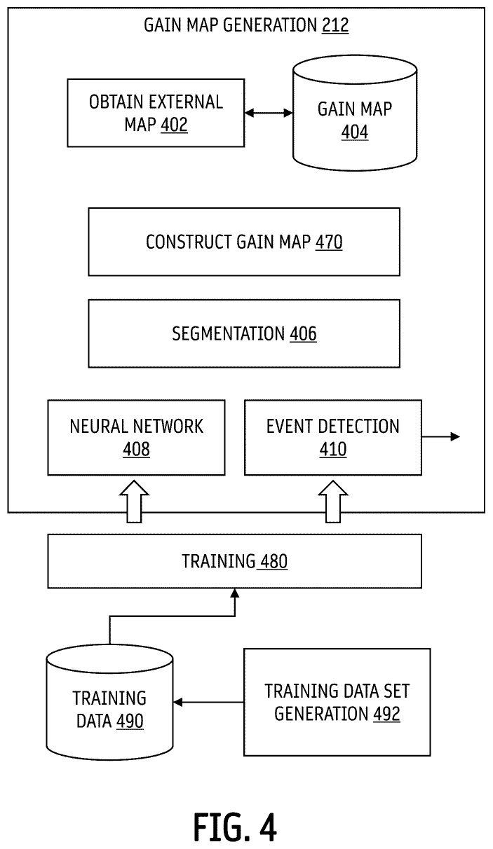

FIG. 4 illustrates gain map generation 212, according to some embodiments of the disclosure. The gain map, e.g., GM_lowres(x,y), as discussed with FIGS. 2-3, can be generated in a variety of ways for different target applications or system specifications. In particular, FIG. 4 illustrates one or more components that can be used.

In some embodiments, gain map generation 212 utilizes a downscaled version of the image of the video to generate the gain map. The downscaled version of the image can have a resolution that is a fraction of the resolution of the full-resolution version of the image. In some embodiments, gain map generation 212 utilizes a full-resolution version of the image of the video to generate the gain map.

In some embodiments, gain map generation 212 includes obtain external map 402 and gain map storage 404. External map 402 can obtain or retrieve the gain map from a gain map storage. In some scenarios involving graphics overlay or object emphasis, the gain maps can be predefined and do not require major adaptations to changes in the scene. This feature of utilizing predefined gain maps can be enabled or disabled through user input received via a graphical user interface, a user interface, a voice user interface, or a gesture user interface.

In some embodiments, gain map generation 212 includes construct gain map 470. Construct gain map 470 can construct the gain map from a description of a graphic or visual effect. In some embodiments, construct gain map 470 can construct the gain map by processing a description that specifies one or more graphical primitives or objects, such that the gain map is not constrained to a predefined map having a fixed-size. Construct gain map 470 can generate gain values by rendering or otherwise deriving a spatial representation of the described graphic or visual effect at a resolution corresponding to a target image and assigning spatially-varying gain values based on the rendered or derived representation. Construct gain map 470 can enable application of graphic overlay or visual effect through gain modulation generated from description data, rather than retrieval of a stored gain map.

In some embodiments, gain map generation 212 includes segmentation 406. Segmentation 406 can generate a segmentation map based on a downscaled version of the image. Gain map generation 212 can generate a gain map based on the segmentation map. In some cases, the gain map assigns different gain values to different segmentation classes in the segmentation map. In some embodiments, the output of segmentation 406, e.g., a segmentation map, can influence one or more operations in gain map generation 212 in one or more complementary ways, depending on the intended visual effect. Segmentation 406 can generate a segmentation map based on a downscaled version of the image, and gain map generation 212 can use that segmentation map as a spatial mask, for example, to apply a graphic or visual effect only to background regions while excluding a person, face, or other salient object. In some embodiments, the segmentation map can be used for object emphasis or de-emphasis, where gain map generation 212 assigns different gain values to different segmentation classes so that selected object classes are brightened, suppressed, or modulated relative to surrounding regions. In this manner, the segmentation map can act both as a binary or multi-class mask that controls where gains are applied and as a semantic guide that determines how strongly different regions are modified, enabling flexible, content-aware gain map construction. In some embodiments, segmentation 406 can be implemented using a neural network that processes a downscaled version of an image to generate a segmentation map identifying object classes or regions of interest, such as people, background, or salient objects. In other embodiments, segmentation 406 can be implemented using image signal processing techniques, such as edge detection, region growing, thresholding, or morphological operations, to separate regions based on intensity, color, or spatial continuity without requiring a trained model. In some examples, these techniques may be combined with lightweight heuristics or post-processing algorithms or calculations applied to a downscaled image to produce a segmentation map suitable for driving gain map generation 212 while maintaining low computational complexity. In some embodiments, segmentation 406 can be implemented utilizing logic or circuits (e.g., components used for segmentation) already in the image processing unit (e.g., image processing unit 190 of FIGS. 1-3). For example, implementing content emphasis can involve applying a gain value greater than 1 for the segment being highlighted (e.g., GM_factor parameter is positive, GM(x,y)>0 in the highlighted segment, and GM(x,y)=0 elsewhere). In another example, implementing background dimming can involve applying a gain value less than 1 for the background segment being dimmed (e.g., GM_factor parameter is negative, GM(x,y)>0 in the background, and GM(x,y)=0 in the foreground).

In some embodiments, gain map generation 212 includes neural network 408 to generate the gain map based on a downscaled version of the image or a derivation of the image (e.g., a feature vector of the image, or a transformed version of the image). Neural network 408 can be implemented as a lightweight convolutional neural network, such as a U-Net-based architecture, or an encoder-decoder-based architecture, to operate on the reduced-resolution input image to infer spatial gain values efficiently. By operating on a downscaled image, neural network 408 can generate a low-resolution gain map with low computational cost and latency, which can then be upscaled and applied within the image processing pipeline. In this manner, neural network 408 can directly encode scene-dependent or semantic information into the gain map without requiring full-resolution processing, enabling real-time, content-aware tone-mapping manipulation. Neural network 408 can compute the gain map directly for applications such as relighting and tone-mapping.

In some embodiments, gain map generation 212 includes event detection 410 to detect an event based on a downscaled version of the image or an audio sample of the video. Gain map generation 212, e.g., one or more components illustrated in gain map generation 212, generates the gain map based on and/or in response to the event. Event detection 410 can detect events from visual content, such as identifying actions or activities using video-based action segmentation, detecting gestures or poses of a person, identifying salient events in a scene, or detecting the appearance, disappearance, or motion of people or objects across frames. Event detection 410 can additionally or alternatively detect events from audio content, such as identifying specific sounds, detecting changes in ambient audio, or recognizing certain words or phrases based on text extracted from audio using speech recognition. Detected events can be used to influence gain map generation 212 in one or more ways. In some cases, an event can enable or disable gain map generation 212 or select between different gain-map-generation modes, such as switching between no effect, object emphasis, background dimming, or graphic overlay. In some cases, an event can modify parameters used by gain map generation 212, for example by changing which graphic or visual effect is constructed or which gain map is obtained, varying spatial placement of a gain map, or adjusting intensity, strength, or temporal behavior of the gain values. In this manner, event detection 410 allows gain map generation 212 to respond dynamically to scene content or user behavior, enabling context-aware visual effects and adaptive tone-mapping manipulation driven by events detected in video or audio streams. In some embodiments, one or more operations in gain map generation 212 can be enabled or disabled based on context and/or scene understanding derived by event detection 410. Event detection 410 can implement a scene understanding network, which can receive a resized or downsized image, optionally with lower FPS (e.g., 0.5 FPS or even lower). The network can analyze the scene and output a decision according to a predefined input prompt which gain map(s) to load and enable.

### A Neural Network Model to Generate Gain Maps for Scene Relighting and Training the Neural Network Model

Implementing neural network 408 as illustrated in FIG. 4 is not trivial. Off-the-shelf neural networks are not trained for applications such as relighting or tone-mapping. Some of these networks are too computationally intensive for real-time video manipulation applications. There is also a lack of high-quality ground truth training data for training neural network 408. For some use cases and applications of gain map generation 212, training 480 is implemented to train one or more neural networks in neural network 408 and/or event detection 410. Training 480 may train the one or more neural networks using training data 490. In some embodiments, training data set generation 492 may be implemented to generate training data 490.

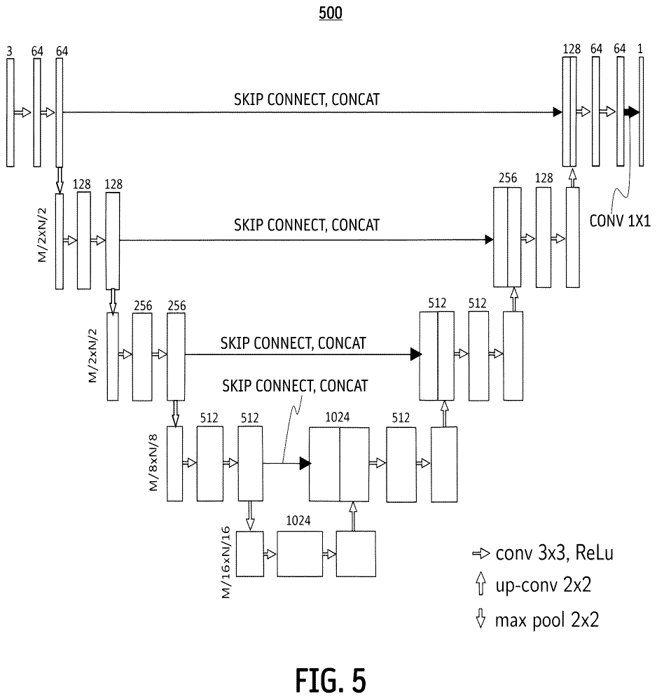

FIG. 5 illustrates neural network 500 for generating a gain map, according to some embodiments of the disclosure. Neural network 500 can be used in gain map generation 212, such as neural network 408. Neural network 500 employs a U-net architecture. Neural network 500 can be used to generate gain maps for relighting and/or scene tone-mapping. The design of neural network 500 may be optimized for specific applications.

As illustrated, the input to neural network 500 has dimensions M×N×3 channels. For the tone-mapping use case, the aspect ratio from the original full-resolution image can be preserved for the input to neural network 500. For example, for 4K video processing, the input to neural network 500 is 512×270×3 pixels. For the relighting use case, the input to the network is a crop with a person's face. The crop can be upscaled to fit a fixed-size expected by neural network 500, and the output of neural network 500 is scaled back and padded with zeros prior to in-pipe scaling.

The architecture of neural network 500 includes an encoder-decoder structure (e.g., the encoder is the left half of neural network 500 and the decoder is the right half of neural network 500) with skip connections. The encoder progressively downsamples the input through four scales (e.g., M×N to M/16×N/16) using convolution and max pooling layers, extracting features from low-level textures to deep representations before reaching a compressed bottleneck with 1024 channels. The decoder mirrors this process with 2×2 up-convolution operations that restore spatial dimensions, while skip connections from corresponding encoder layers preserve fine-grained details. The final 1×1 convolution layer produces pixel-wise gain predictions for the output.

The U-Net architecture of neural network 500 is particularly useful for gain map generation because the architecture naturally supports generating a dense, spatially aligned output gain map from a downscaled input image while preserving both global context and fine spatial structure. The encoder path captures large-scale scene and lighting context that is important for tone-mapping and relighting decisions, while the decoder path with skip connections restores spatial detail so that gain values align accurately with object boundaries and facial regions when the gain map is later upscaled. This combination allows the network to operate efficiently at low-resolution, produce a gain map at the same resolution as the downscaled image, and still deliver high-quality, artifact-free modulation when applied in the high-bit-depth processing pipeline.

Producing a gain map to improve backlit scenes and achieve high dynamic range images is a technical challenge and a severe pain point in camera solutions. Referring back to FIG. 4, a non-trivial implementation of training 480 and/or training data set generation 492 can be used to train neural network 408.

In some embodiments, training data set generation 492 follows a supervised training approach, in which training data 490 includes training images that are paired with reference outputs or target enhanced images that represent a desired visual result. In this approach, training data set generation 492 may produce training data 490 by processing training images to produce target enhanced images using manual tuning, artist-authored adjustments, multi-exposure fusion, or high-quality offline processing. Neural network 408 is then trained by training 480 to generate gain maps such that, when the gain maps are upscaled and applied to the training images, the resulting enhanced images approximate the corresponding reference outputs. This supervised approach allows explicit control over the visual outcome by directly learning a mapping from input images to desired enhancements.

In other embodiments, training data set generation 492 follows a non-supervised or self-supervised training approach, in which no explicit ground-truth gain maps or reference enhanced images are provided in training data 490. Instead, training images are processed through a simulated version of the image processing pipeline. Neural network 408 generates a gain map from a downscaled input, the gain map is upscaled, and the upscaled gain map is applied to the original high-bit-depth training image from training data 490 to produce an enhanced training image. Training 480 evaluates one or more quality metrics directly on the enhanced training image, such as preservation of detail, avoidance of halos, contrast consistency, or achievement of a target brightness distribution, and these metrics are used by training 480 to update parameters of neural network 408. In this manner, neural network 408 learns to generate gain maps that produce visually desirable results when applied in the pipeline, without relying on explicitly labeled training outputs in training data 490.

In a scene tone-mapping application, similar to inference, also during training, training data set generation 492 performs one or more operations to produce suitable input images to neural network 408. The input image (e.g., having size H×W×3, 15 bits) from training data 490 can be downscaled by a factor of ⅛: I_{in_small}=Downscale(Iᵢₙ(x,y), ⅛). The downscaled image passes through a simulated processing pipeline, including applying a gain function (e.g., GTM_gain(x,y) based on a global tone-mapping curve) and performing bit-depth reduction to 8-bit. The resulting image, I_{small_8bit}, is passed through neural network 408 (e.g., neural network 500 of FIG. 5). The gain map obtained from neural network 408, GMₛₘₐₗₗ, is of the same size as I_{small_8bit}, but with one channel.

After obtaining the gain map, training 480 can obtain enhanced images based on which a loss can be calculated. To compute the loss, the gain map GMₛₘₐₗₗ is upscaled to full-resolution: GM_{full}=Upscale(GMₛₘₐₗₗ). The enhanced image is obtained by multiplicatively applying the gain map to the original input:

$${I}_{enhanced} ( x , y ) = {I}_{i n} ( x , y ) * GTM\_gain ( x , y ) * ( 1 + GM\_factor * {GM}_{full} ( x , y ) )$$

The loss is computed on the full-resolution enhanced image I_{enhanced}(x,y). Training 480 updates one or more parameters of neural network 408 in a manner that minimizes the loss.

An example of a loss function, based on one or more quality metrics of the full-resolution enhanced image I_{enhanced}(x,y), can be defined as follows:

$$L = {λ}_{1} {L}_{spatial} + {λ}_{2} {L}_{detail} + {λ}_{3} {L}_{contrast} + {λ}_{4} {L}_{halo}$$

L represents a total loss used to train neural network 408 to generate gain maps that produce visually acceptable results when applied within an image processing pipeline (e.g., image processing pipeline 292 of FIG. 2, and image processing pipeline 392 of FIGS. 3). λ₁, λ₂, λ₃, and λ₄ are weighting coefficients that control the relative influence of each loss component. Lₛₚₐₜᵢₐₗ is a spatial consistency loss that encourages preservation of structural integrity by penalizing distortions in spatial relationships or edge geometry, ensuring that applying an upscaled gain map does not introduce shifts, warping, or false contours in the image. Using Lₛₚₐₜᵢₐₗ maintains edge geometry and prevents distortions. L_{detail} is a detail preservation loss that promotes retention of fine, low-contrast details by encouraging selective enhancement of shadow regions while avoiding over-amplification of highlights, thereby maintaining texture visibility after tone-mapping manipulation. Using L_{detail} preserves information in shadows and preserves saturated highlights. L_{contrast} is a global contrast regularization term that constrains overall tonal balance by limiting excessive compression or expansion of dynamic range, helping ensure that contrast changes remain perceptually natural across different scenes. Using L_{contrast} maintains global tonal balance. Lₕₐₗₒ is a halo-suppression loss that penalizes the creation of artificial gradients or ringing artifacts near object boundaries, reducing visible halos that can arise from spatially-varying gain discontinuities after upscaling. Using Lₕₐₗₒ eliminates halos caused by the upscaled gain map. Together, these loss components allow robust unsupervised learning without ground truth of a tone-mapping function optimized for backlit scenes, delivering perceptually balanced results free of halos and artifacts. It is envisioned that one or more loss components can be used in the loss function.

In some embodiments, Lₛₚₐₜᵢₐₗ serves the purpose of preserving structural integrity and avoiding geometric or edge distortions. Because the gain map is applied after upscaling, it is preferable that the gain map does not alter the local spatial relationships in the input image. Lₛₚₐₜᵢₐₗ can be calculated as follows:

$${L}_{spatial} = {‖ ∇ {I}_{enhanced} - ∇ {I}_{i n} ‖}_{1}$$

∇ denotes spatial gradients. ∥⋅∥₁ denotes the L1 norm or absolute value norm. Lₛₚₐₜᵢₐₗ ensures that the direction and magnitude of edges remain consistent, preventing false contours or shifts caused by uneven gain.

In some embodiments, L_{detail} serves the purpose of ensuring fine details remain visible in both dark and bright regions. The L_{detail} loss encourages selective amplification of shadowed areas while avoiding over-enhancement of highlights. A dynamic-range-aware weighting can be applied. L_{detail} can be computed as follows:

$${L}_{detail} = {\sum }_{i , j} w ( i , j ) \cdot \vert {I}_{enhanced} ( i , j ) - {I}_{i n} ( i , j ) \vert$$

$$w ( i , j ) = \{ \begin{matrix}1 - \frac{{I}_{i n} ( i , j )}{{T}_{dark}} & {I}_{i n} ( i , j ) < {T}_{dark} \\ β & {I}_{i n} ( i , j ) < {T}_{bright} \\ 0 & otherwise\end{matrix}$$

In some implementations, T_{dark}=0.2, T_{bright}=0.8, and β=0.4.

L_{detail} serves to explicitly bias neural network 408 to enhance shadowed regions and protect highlights from clipping.

In some embodiments, L_{contrast} serves to maintain overall tonal balance and prevent flattening or over-stretching of the dynamic range. L_{contrast} accounts for the global variance of intensity values between input and output images. L_{contrast} can be computed as follows:

$${L}_{contrast} = ⌈ σ ( {I}_{enhanced} ) - σ ( {I}_{i n} ) ⌉$$

σ(⋅) denotes the standard deviation of pixel intensities. The L_{contrast} regularization term ensures that contrast changes are perceptually natural and consistent across different illumination conditions.

In some embodiments, Lₕₐₗₒ serves to suppress visible halos and ringing artifacts that may appear near object boundaries due to upscaled gain discontinuities. The Lₕₐₗₒ loss penalizes the creation of new gradients in regions that were originally smooth, while preserving legitimate edges. Lₕₐₗₒ can be computed as follows:

$${L}_{halo} = {\sum }_{i , j} {w ( i , j ) [ max ( 0 , {g}_{enhanced} ( i , j ) - {g}_{i n} ( i , j ) ]}^{2}$$

$${g}_{i n} ( i , j ) = ‖ ∇ {I}_{i n} ( i , j ) ‖ , {g}_{enhanced} ( i , j ) = ‖ ∇ {I}_{enhanced} ( i , j ) ‖$$

$$w ( i , j ) = exp ( - γ {g}_{i n} ( i , j ) )$$

The edge-aware weighting term (γ) can be set to be 100, for images normalized to [0, 1]. When the input region is smooth (e.g., gᵢₙ is small), any new gradient in I_{enhanced} is penalized heavily, thereby preventing halos. When a true edge exists (e.g., gᵢₙ is large), the penalty relaxes, thereby allowing natural edge contrast.

In some embodiments, the weighting coefficients are set to λ₁=0.8, λ₂=1.5, λ₃=0.3, and λ₄=2.0. In some embodiments, the weighting coefficients are set to λ₁=1.0, λ₂=1.2, λ₃=0.4, λ₄=1.6.

In a face relighting application, training data set generation 492 implements a generative approach to create a training dataset and stores the training data set in training data 490. A generative model in training data set generation 492 accepts a noise vector as input, conditioned on both scene and lighting parameters. The training process implemented in neural network 408 involves two distinct phases: (1) initially using randomized lighting conditions, (2) lighting configurations designed to replicate ring light effects. The target lighting parameters for the ring light effect were determined by estimating lighting properties from an example reference image. The reference image scene includes a person facing the camera and illuminated by a frontal ring light source. This generation approach produced paired training samples for training data 490, where each pair contained the same individual's face under two different lighting scenarios, e.g., one with random illumination (input) and another with desired target lighting (ground truth). Through this methodology, corresponding input and target video sequences can be generated by training data set generation 492 and stored in training data 490.

Subsequently, training 480 uses training data 490 to train neural network 408 to calculate the gain map to transform input images to achieve the target lighting appearance. In some embodiments, training operations in training 480 are performed in linear color space. To account for temporal information, the input to neural network 408 can be structured as [B*T,C,H,W]. B represents the batch size, T represents the number of consecutive video frames. C represents the number of channels. H represents the height of the input images. W represents the width of the input images.

Training 480 can calculate a loss based on corresponding input and target video sequences, and update one or more parameters of neural network 408 to minimize or optimize the loss. An example of a loss function can incorporate one or more loss components: low-frequency loss, high-frequency loss, and temporal loss. Training 480 can construct Laplacian pyramids for the input, output, and ground truth images. Training 480 can calculate the low-frequency loss using L1 distance between the smallest images (low-frequency residuals) of the ground truth and output pyramids. Training 480 can calculate the high-frequency loss by applying L1 loss calculations across the remaining pyramid levels between input and output images. The loss function design enables the neural network to extract color information from the labels while preserving fine details from the input. To maintain temporal coherence and eliminate flickering artifacts in the output sequence, training 480 can compute an L2 loss term that measures the difference between the temporal derivatives of output images and ground truth labels.

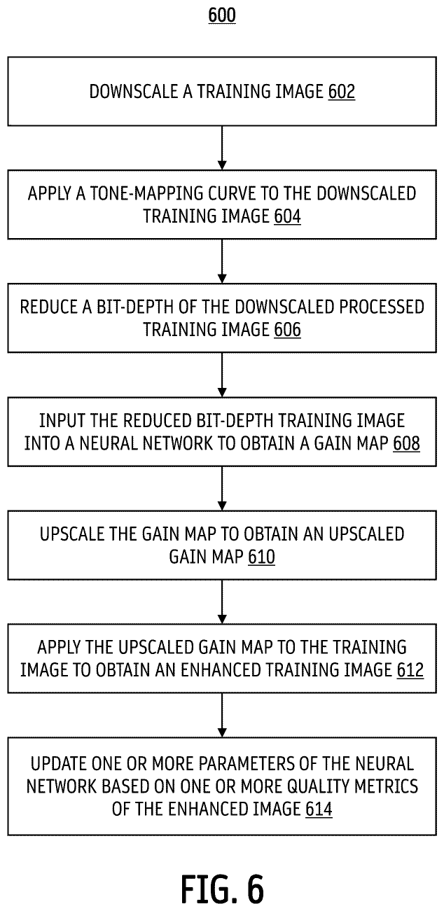

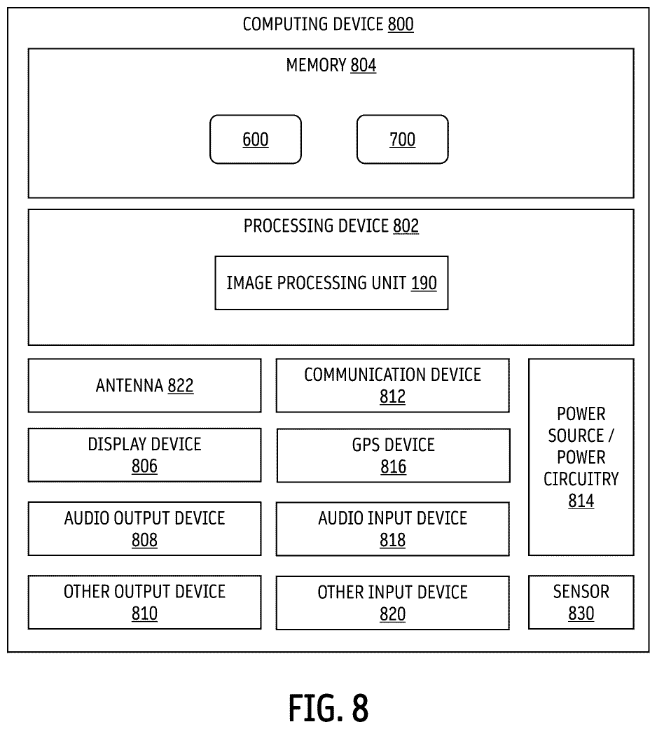

FIG. 6 is a flowchart illustrating method 600 for training a neural network to generate a gain map, according to some embodiments of the disclosure. Method 600 can be encoded in instructions that can be executed by one or more processors and stored in one or more non-transitory computer-readable media. Method 600 can be performed using a computing device, such as computing device 800 in FIG. 8.

In 602, a training image is downscaled to generate a downscaled training image.

In 604, a tone-mapping curve is applied to the downscaled training image to generate a processed training image.

In 606, the bit-depth of the processed training image is reduced to generate a reduced bit-depth training image.

In 608, the reduced bit-depth training image is input into a neural network to obtain a gain map.

In 610, the gain map is upscaled to obtain an upscaled gain map.

In 612, the upscaled gain map is applied to the training image to obtain an enhanced training image. Optionally, the tone-mapping curve is applied to the training image, or the enhanced training image.

In 614, one or more parameters of the neural network are updated based on one or more quality metrics of the enhanced training image.

In some embodiments, the one or more parameters are updated using a loss function defined based on the one or more quality metrics of the enhanced image. The loss function can include one or more loss components. An example of a loss component includes a spatial consistency loss, which can help preserve edge geometry between the training image and the enhanced image. Another example of a loss component includes a detail preservation loss, which can encourage amplification of shadow regions while limiting amplification of highlight regions. Another example of a loss component includes a global contrast loss, which can constrain changes in global intensity distribution between the training image and the enhanced image. Another example of a loss component includes a halo suppression loss, which can penalize creation of new gradients in spatially smooth regions of the training image. In some cases, the loss function comprises a weighted combination of two or more of: a spatial consistency loss, a detail preservation loss, a global contrast loss, and a halo suppression loss.

Method 600 allows for training of a neural network (e.g., neural network 408 of FIG. 4, and neural network 500 of FIG. 5) to be performed without a ground-truth tone-mapped reference image for the training image. The loss function used in training the neural network can be evaluated directly on the enhanced image generated by applying the upscaled gain map to the training image.

In some embodiments, the training images include scenes having a foreground region with lower luminance than a background region. In some embodiments, the loss function used in training the neural network increases visibility of the foreground region while reducing highlight clipping in the background region.

Method 600 can be applied to train a neural network to output a single-channel gain map representing spatially-varying multiplicative gains.

### Example Method for Efficient Video Manipulation

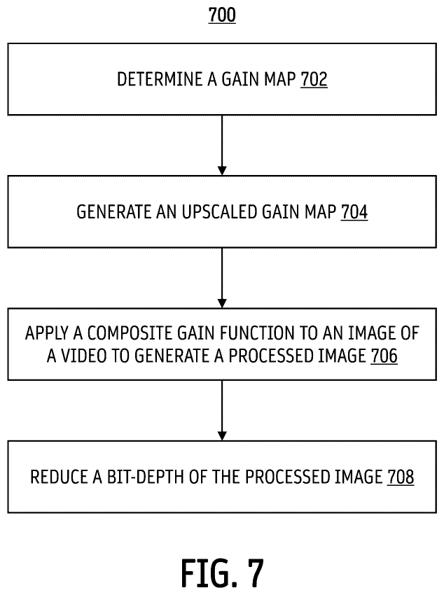

FIG. 7 is a flowchart illustrating method 700 for efficient manipulation of video, according to some embodiments of the disclosure. Method 700 can be implemented or carried out by one or more components or logic in image processing pipeline 292, image processing pipeline 392, and gain map generation pipeline 294 as illustrated in FIGS. 1-4. Method 700 can be encoded in instructions that can be executed by image processing unit 190 and/or other processor(s) and stored in one or more non-transitory computer-readable media. Method 700 can be implemented as part of firmware or software for image processing unit 190 and/or other processor(s). Method 700 can be performed using a computing device, such as computing device 800 in FIG. 8.

In 702, a gain map is determined. In some embodiments, the gain map is determined using a neural network based on a downscaled version of an image of a video or a derivation thereof.

In 704, an upscaled gain map can be generated based on the gain map.

In 706, a composite gain function can be applied to the image of the video to generate a processed image. The composite gain function can be based on a gain function and the upscaled gain map.

In 708, a bit-depth of the processed image is reduced.

In some embodiments, determining the gain map in 702 can include generating the gain map based on a downscaled version of the image. In some embodiments, determining the gain map in 702 can include retrieving the gain map from a gain map storage. In some embodiments, determining the gain map in 702 can include rendering the gain map from a description of a graphic or visual effect. In some embodiments, determining the gain map in 702 can include generating a segmentation map based on a downscaled version of the image, wherein the gain map is based on the segmentation map. The gain map can assign different gain values to different segmentation classes in the segmentation map. In some embodiments, determining the gain map in 702 can include generating, by a neural network, the gain map based on a downscaled version of the image or a derivation of the image. In some embodiments, determining the gain map in 702 can include detecting an event based on a downscaled version of the image or an audio sample of the video, and determining the gain map based on the event.

### Example Computing Device

FIG. 8 is a block diagram of an apparatus or a system, e.g., an example computing device 800, according to some embodiments of the disclosure. One or more computing devices 800 may be used to implement the functionalities described with the FIGS. and herein. A number of components illustrated in FIG. 8 can be included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, and the computing device 800 may include interface circuitry for coupling to the one or more components. For example, the computing device 800 may not include a display device 806, and may include display device interface circuitry (e.g., a connector and driver circuitry) to which a display device 806 may be coupled. In another set of examples, the computing device 800 may not include an audio input device 818 or an audio output device 808 and may include audio input or output device interface circuitry (e.g., connectors and supporting circuitry) to which audio input device 818 or audio output device 808 may be coupled.

Computing device 800 may include processing device 802 (e.g., one or more processing devices, one or more of the same type of processing device, one or more of different types of processing devices). Processing device 802 may include electronic circuitry that processes electronic data from data storage elements (e.g., registers, memory, resistors, capacitors, quantum bit cells) to transform that electronic data into other electronic data that may be stored in registers and/or memory. Examples of processing device 802 may include a central processing unit (CPU), a graphics processing unit (GPU), an image processing unit, an image signal processor, a quantum processor, a machine learning processor, an artificial intelligence processor, a neural network processor, an artificial intelligence accelerator, an application-specific integrated circuit (ASIC), an analog signal processor, an analog computer, a microprocessor, a digital signal processor, a field-programmable gate array (FPGA), a tensor processing unit (TPU), a neural network hardware accelerator, a deep neural network hardware accelerator, etc. Processing device 802 may have synchronization primitives/resources such as hardware barriers for synchronization operations being executed on the processing device 802.

In some embodiments, processing device 802 can include or be image processing unit 190, as described with reference to FIGS. 1-3. Processing device 802 may implement one or more hardware, logic, firmware, or software components corresponding to image processing unit 190. In some examples, image processing unit 190 is a dedicated image signal processor, image processing unit, application-specific integrated circuit, or system-on-chip component to execute image processing operations. In other examples, image processing unit 190 may be implemented as one or more functional or logic blocks executed on processing device 802. Accordingly, references to operations performed by image processing unit 190 may correspond to operations performed by processing device 802, whether implemented as dedicated hardware, programmable logic, firmware, or instructions executed by processing device 802. In some embodiments, image processing unit 190 can be implemented as a standalone integrated circuit to perform one or more functions described herein. In some embodiments, image processing unit 190 can be integrated as a functional or circuit block within an SoC and as part of processing device 802, sharing resources such as memory, interconnect, and control logic with other processing components.

In some embodiments, memory 804 includes one or more non-transitory computer-readable media storing instructions executable to perform operations described with the FIGS. and herein. Memory 804 may include one or more non-transitory computer-readable media storing instructions executable to perform one or more operations described with FIGS. 1-4. Memory 804 may include one or more non-transitory computer-readable media storing instructions executable to perform one or more operations described with method 600 of FIG. 6. Memory 804 may include one or more non-transitory computer-readable media storing instructions executable to perform one or more operations described with method 700 of FIG. 7. Example parts, e.g., parts illustrated as part of image processing unit 190 in FIGS. 1-3 and parts illustrated as part of gain map generation 212 of FIG. 4, training 480, and training data set generation 492, may be encoded as instructions and stored in memory 804. The instructions stored in the one or more non-transitory computer-readable media may be executed by processing device 802.

In some embodiments, memory 804 may store data, e.g., data structures, binary data, bits, metadata, files, blobs, etc., as described with the FIGS. and herein. Memory 804 may store inputs, intermediate inputs, intermediate outputs, and outputs of method 600 of FIG. 6 and method 700 of FIG. 7. Memory 804 may store inputs, intermediate inputs, intermediate outputs, and outputs of components illustrated in FIGS. 1-4, such as video 242, processed video 244, gain maps, upscaled gain maps, processed images, gain functions, etc. Memory 804 may store gain map storage 404.

In some embodiments, memory 804 may store one or more machine learning models (and/or parts thereof). Memory 804 may store training data for training (or trained) one or more machine learning models, such as neural network 408, neural network 500, a transformer-based neural network, a multilayer perceptron model, a neural network model, and other models and/or encoders mentioned herein. Memory 804 may store training data 490. Memory 804 may store instructions that perform operations associated with training the one or more machine learning models. Memory 804 may store input data, output data, intermediate outputs, intermediate inputs of one or more machine learning models. Memory 804 may store instructions to perform one or more operations of the one or more machine learning models. Memory 804 may store one or more parameters used by the one or more machine learning models. Memory 804 may store information that encodes how processing units of the machine learning model are connected with each other.

In some embodiments, computing device 800 may include a communication device 812 (e.g., one or more communication devices). For example, communication device 812 may be configured for managing wired and/or wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Communication device 812 may implement any of a number of wireless standards or protocols. Computing device 800 may include antenna 822 to facilitate wireless communications and/or to receive other wireless communications (such as radio frequency transmissions). Computing device 800 may include receiver circuits and/or transmitter circuits. In some embodiments, communication device 812 may manage wired communications, such as electrical, optical, or any other suitable communication protocols (e.g., Ethernet). As noted above, communication device 812 may include multiple communication chips. For instance, a first communication device 812 may be dedicated to shorter-range wireless communications. In some embodiments, a first communication device 812 may be dedicated to wireless communications, and a second communication device 812 may be dedicated to wired communications.

Computing device 800 may include power source/power circuitry 814. The power source/power circuitry 814 may include one or more energy storage devices (e.g., batteries or capacitors) and/or circuitry for coupling components of the computing device 800 to an energy source separate from the computing device 800 (e.g., DC power, AC power, etc.).

Computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

Computing device 800 may include audio output device 808 (or corresponding interface circuitry, as discussed above). Audio output device 808 may include any device that generates an audible indicator, such as speakers, headsets, or earbuds, for example.

Computing device 800 may include audio input device 818 (or corresponding interface circuitry, as discussed above). Audio input device 818 may include any device that generates a signal representative of a sound, such as microphones, microphone arrays, or digital instruments (e.g., instruments having a musical instrument digital interface (MIDI) output).

Computing device 800 may include GPS device 816 (or corresponding interface circuitry, as discussed above). GPS device 816 may be in communication with a satellite-based system and may receive a location of computing device 800, as known in the art.

Computing device 800 may include sensor 830 (or one or more sensors). Computing device 800 may include corresponding interface circuitry, as discussed above). Sensor 830 may sense physical phenomena and translate the physical phenomena into electrical signals that can be processed by, e.g., processing device 802. Examples of sensor 830 may include: image sensor, capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 800 may include another output device 810 (or corresponding interface circuitry, as discussed above). Examples of the other output device 810 may include an audio codec, a video codec, a printer, a wired or wireless transmitter for providing information to other devices, haptic output device, gas output device, vibrational output device, lighting output device, home automation controller, or an additional storage device.

Computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 800 may have any desired form factor, such as a handheld or mobile computer system (e.g., a cell phone, a smartphone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 800 may be any other electronic device that processes data.

### Select Examples

Example 1 provides a computing apparatus, including a gain map generation pipeline to output a gain map, the gain map generation pipeline including a neural network to generate the gain map based on a downscaled version of an image of a video or a derivation thereof; and an image processing pipeline to process the image of the video, the image processing pipeline including an upscaler to generate an upscaled gain map based on the gain map from the gain map generation pipeline; a gain function application part to apply a composite gain function to the image to generate a processed image, where the composite gain function is based on a gain function and the upscaled gain map; and a bit reduction part to reduce a bit-depth of the processed image.

Example 2 provides the computing apparatus of example 1, where the gain function is based on a tone-mapping curve.

Example 3 provides the computing apparatus of example 1 or 2, where the composite gain function is further based on a details map.

Example 4 provides the computing apparatus of any one of examples 1-3, where the bit reduction part is downstream of the gain function application part.

Example 5 provides the computing apparatus of any one of examples 1-4, where the gain map generation pipeline includes a segmentation part to generate a segmentation map based on the downscaled version of the image, where the gain map is based on the segmentation map.

Example 6 provides the computing apparatus of example 5, where the gain map assigns different gain values to different segmentation classes in the segmentation map.

Example 7 provides the computing apparatus of any one of examples 1-6, where: the gain map generation pipeline includes an event detector to detect an event based on the downscaled version of the image or an audio sample of the video; and the gain map generation pipeline is further to generate the gain map based on the event.

Example 8 provides one or more non-transitory computer-readable media storing instructions that, when executed by one or more processors, cause the one or more processors to: generate a gain map, using a neural network, based on a downscaled version of an image of a video or a derivation thereof; generate an upscaled gain map based on the gain map; apply a composite gain function to the image of the video to generate a processed image, where the composite gain function is based on a gain function and the upscaled gain map; and reduce a bit-depth of the processed image.

Example 9 provides the one or more non-transitory computer-readable media of example 8, where the gain map is generated based on a segmentation map produced from the downscaled version of the image.

Example 10 provides the one or more non-transitory computer-readable media of example 9, where the gain map assigns different gain values to different segmentation classes in the segmentation map.

Example 11 provides the one or more non-transitory computer-readable media of any one of examples 8-10, where: the gain map is generated based on an event detected by an event detector; and the event detector is to detect the event based on the downscaled version of the image or an audio sample of the video.

Example 12 provides the one or more non-transitory computer-readable media of any one of examples 8-11, where the gain function is based on a tone-mapping curve.

Example 13 provides the one or more non-transitory computer-readable media of any one of examples 8-11, where the composite gain function is further based on a details map.

Example 14 provides a method for manipulation of a video, including determining a gain map using a neural network based on a downscaled version of an image of the video or a derivation thereof; generating an upscaled gain map based on the gain map; applying a composite gain function to the image of the video to generate a processed image, where the composite gain function is based on a gain function and the upscaled gain map; and reducing a bit-depth of the processed image.

Example 15 provides the method of any one of examples 14, where determining the gain map includes generating a segmentation map based on the downscaled version of the image, where the gain map is based on the segmentation map.

Example 16 provides the method of example 15, where the gain map assigns different gain values to different segmentation classes in the segmentation map.

Example 17 provides the method of any one of examples 14-16, where determining the gain map includes detecting an event based on the downscaled version of the image or an audio sample of the video; and determining the gain map based on the event.

Example 18 provides the method of any one of examples 14-17, where the gain function is based on a tone-mapping curve.

Example 19 provides the method of any one of examples 14-18, where the composite gain function is further based on a details map.

Example 20 provides the method of any one of examples 14-19, where the bit-depth of the processed image is reduced after the composite gain function is applied to the image of the video.

Example 21 provides a method for training a neural network, including downscaling a training image to generate a downscaled training image; applying a tone-mapping curve to the downscaled training image to generate a processed training image; reducing a bit-depth of the processed training image to generate a reduced bit-depth training image; inputting the reduced bit-depth training image into the neural network to obtain a gain map; upscaling the gain map to obtain an upscaled gain map; applying the upscaled gain map to the training image to obtain an enhanced training image; and updating one or more parameters of the neural network based on one or more quality metrics of the enhanced training image.

Example 22 provides an apparatus including means for performing a method according to any one of examples 14-21.

Example 23 provides a computer program product including instructions which, when executed by a processor, cause the processor to perform a method according to any one of examples 14-21.

Example 24 provides machine-readable storage including machine-readable instructions, when executed, cause a computer to implement a method according to any one of examples 14-21.

Example 25 provides a computer program including instructions which, when the computer program is executed by a processing device, cause the processing device to carry out a method according to any one of examples 14-21.

Example 26 provides a computer-implemented system, including one or more processors, and one or more non-transitory computer-readable media storing instructions that, when executed by the one or more processors, cause the one or more processors to perform a method according to any one of examples 14-21.

### Variations and Remarks

Although the operations of the example method shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description and the accompanying drawings.

1. A computing apparatus, comprising:
a gain map generation pipeline to output a gain map, the gain map generation pipeline comprising a neural network to generate the gain map based on a downscaled version of an image of a video or a derivation thereof; and
an image processing pipeline to process the image of the video, the image processing pipeline comprising:
an upscaler to generate an upscaled gain map based on the gain map from the gain map generation pipeline;
a gain function application part to apply a composite gain function to the image to generate a processed image, wherein the composite gain function is based on a gain function and the upscaled gain map; and
a bit reduction part to reduce a bit-depth of the processed image.

2. The computing apparatus of claim 1, wherein the gain function is based on a tone-mapping curve.

3. The computing apparatus of claim 1, wherein the composite gain function is further based on a details map.

4. The computing apparatus of claim 1, wherein the bit reduction part is downstream of the gain function application part.

5. The computing apparatus of claim 1, wherein the gain map generation pipeline includes:
a segmentation part to generate a segmentation map based on the downscaled version of the image, wherein the gain map is based on the segmentation map.

6. The computing apparatus of claim 5, wherein the gain map assigns different gain values to different segmentation classes in the segmentation map.

7. The computing apparatus of claim 1, wherein:
the gain map generation pipeline includes an event detector to detect an event based on the downscaled version of the image or an audio sample of the video; and
the gain map generation pipeline is further to generate the gain map based on the event.

8. One or more non-transitory computer-readable media storing instructions that, when executed by one or more processors, cause the one or more processors to:
generate a gain map, using a neural network, based on a downscaled version of an image of a video or a derivation thereof;
generate an upscaled gain map based on the gain map;
apply a composite gain function to the image of the video to generate a processed image, wherein the composite gain function is based on a gain function and the upscaled gain map; and
reduce a bit-depth of the processed image.

9. The one or more non-transitory computer-readable media of claim 8, wherein the gain map is generated based on a segmentation map produced from the downscaled version of the image.

10. The one or more non-transitory computer-readable media of claim 9, wherein the gain map assigns different gain values to different segmentation classes in the segmentation map.

11. The one or more non-transitory computer-readable media of claim 8, wherein:
the gain map is generated based on an event detected by an event detector; and
the event detector is to detect the event based on the downscaled version of the image or an audio sample of the video.

12. The one or more non-transitory computer-readable media of claim 8, wherein the gain function is based on a tone-mapping curve.

13. The one or more non-transitory computer-readable media of claim 8, wherein the composite gain function is further based on a details map.

14. A method for manipulation of a video, comprising:
determining a gain map using a neural network based on a downscaled version of an image of the video or a derivation thereof;
generating an upscaled gain map based on the gain map;
applying a composite gain function to the image of the video to generate a processed image, wherein the composite gain function is based on a gain function and the upscaled gain map; and
reducing a bit-depth of the processed image.

15. The method of any one of claim 14, wherein determining the gain map comprises:
generating a segmentation map based on the downscaled version of the image, wherein the gain map is based on the segmentation map.

16. The method of claim 15, wherein the gain map assigns different gain values to different segmentation classes in the segmentation map.

17. The method of claim 14, wherein determining the gain map comprises:
detecting an event based on the downscaled version of the image or an audio sample of the video; and
determining the gain map based on the event.

18. The method of claim 14, wherein the gain function is based on a tone-mapping curve.

19. The method of claim 14, wherein the composite gain function is further based on a details map.

20. The method of claim 14, wherein the bit-depth of the processed image is reduced after the composite gain function is applied to the image of the video.
